(19) United States
(12) Patent Application Publication
(10) Pub. No.: US 2016/0008971 A1
(43) Pub. Date: Jan. 14, 2016

(54) CLEANING ASSEMBLIES HAVING IMPROVED HANDLE GRIPS

(71) Applicant: Unger Marketing International, LLC, Bridgeport, CT (US)

(72) Inventors: William Harrington, Charlestown, RI (US); James M. Buckley, New Hartford, CT (US); Scott Henderson, Brooklyn, NY (US)

(21) Appl. No.: 14/796,217

(22) Filed: Jul. 10, 2015

Related U.S. Application Data
(60) Provisional application No. 62/023,022, filed on Jul. 10, 2014.

(51) Int. Cl. B25G 1/10

(52) U.S. Cl. CPC B25G 1/102

(57) ABSTRACT

Cleaning tools that have improved gripping handles are provided. The gripping handles have a plurality of parallel gripping ribs that run in a direction that is normal to a primary cleaning direction of the tool and the ribs are parallel to the longitudinal axis of handle. The cleaning tools can have two gripping handle portions angled with respect to one another with at least one of the handles having a plurality of parallel gripping ribs that run in a direction that is normal to a primary cleaning direction of the tool. The gipping ribs can optionally run continuously from the first cleaning portion to the second cleaning portion.

### CROSS REFERENCE TO RELATED APPLICATIONS

This application claims the benefit of U.S. Provisional Application Serial No. 62/023,022 filed on Jul. 10, 2014, the entire contents of which are incorporated by reference herein.

### BACKGROUND

1. Field of the Disclosure

The present disclosure is related to cleaning assemblies. More particularly, the present disclosure is related to cleaning assemblies having a cleaning tool and an improved handle grip for the cleaning tool.

2. Description of Related Art

Cleaning tools such as dusters, scrub brushes, window squeegees, and others are well known. The commercial success of such cleaning tools is often dependent, at least in part, upon the user's comfort and effectiveness in holding and grasping the tool during use. Therefore, many prior art tools are formed into assemblies by connection or being integrally formed with a handle, where the handle often includes a handle grip.

For example, some prior art cleaning assemblies include handle grips made of rigid and/or resilient material, which are intended to improve the user's comfort and effectiveness in holding and grasping the assembly during use.

However, it has been determined by the present disclosure that there is a continuing need for improved handle grips for cleaning assemblies.

### SUMMARY

Cleaning assemblies are provided that have improved gripping handles connected to cleaning tools. The gripping handles have a plurality of parallel gripping ribs that run in a direction that is normal to a primary cleaning direction of the tool and parallel to the longitudinal axis of the handle.

In some embodiments, the cleaning assemblies have two gripping handle portions angled with respect to one another with at least one of the handles having a plurality of parallel gripping ribs that run in a direction that is normal to a primary cleaning direction of the tool. The gripping ribs can, in other embodiments, run continuously from the first cleaning portion to the second cleaning portion.

A cleaning assembly is provided that includes a cleaning tool with a primary cleaning direction and a gripping handle connected to the cleaning tool. The gripping handle has a rigid base with a longitudinal axis and a plurality of elastomeric gripping ribs. The ribs run parallel to one another along the longitudinal axis. The cleaning tool and the gripping handle are connected so that the ribs are not parallel to the primary cleaning direction.

In some embodiments either alone or in combination with one or more of the aft mentioned embodiments, the cleaning tool and the gripping handle are connected to one another so that the ribs are perpendicular to the primary cleaning direction.

In some embodiments either alone or in combination with one or more of the afore and/or aft mentioned embodiments, the cleaning tool is a fan blade cleaning tool, a dusting tool, a squeegee, a window washer, or a brush.

In some embodiments either alone or in combination with one or more of the afore and/or aft mentioned embodiments, the ribs depend upward from a web with the rigid base supporting the web.

In some embodiments either alone or in combination with one or more of the afore and/or aft mentioned embodiments, the ribs and the web are molded onto the rigid base so that the gripping handle is an integrally formed unit.

In some embodiments either alone or in combination with one or more of the afore and/or aft mentioned embodiments, the ribs and the web are formed a thermoplastic elastomer having a durometer of between 20 and 70.

In some embodiments either alone or in combination with one or more of the afore and/or aft mentioned embodiments, the ribs have a ratio of maximum height to width of between 4:1 and 1:4.

In some embodiments either alone or in combination with one or more of the afore and/or aft mentioned embodiments, the rigid base supports the ribs.

In some embodiments either alone or in combination with one or more of the afore and/or aft mentioned embodiments, the ribs are molded onto the rigid base so that the gripping handle is an integrally formed unit.

In some embodiments either alone or in combination with one or more of the afore and/or aft mentioned embodiments, the ribs have a ratio of maximum height to width of between 4:1 and 1:4.

In some embodiments either alone or in combination with one or more of the afore and/or aft mentioned embodiments, the gripping handle includes a first handle portion and a second handle portion each having the longitudinal axis. Here, the longitudinal axes of the first and second handle portions are angled (i.e., not parallel) with respect to one another.

In some embodiments either alone or in combination with one or more of the afore and/or aft mentioned embodiments, the first and second handle portions each include the plurality of elastomeric gripping ribs running parallel to one another along the longitudinal axis, respectively.

In some embodiments either alone or in combination with one or more of the afore and/or aft mentioned embodiments, the ribs run continuously from the first handle portion to the second handle portion.

A cleaning assembly is also provided that includes a cleaning tool with a primary cleaning direction and a gripping handle connected to the cleaning tool. The gripping handle has a rigid base with a longitudinal axis and a plurality of elastomeric gripping ribs. The ribs run parallel to one another along the longitudinal axis, have a durometer of between 20-70, and a ratio of maximum height to width of between 4:1 and 1:4.

In some embodiments either alone or in combination with one or more of the afore and/or aft mentioned embodiments, the cleaning tool and the gripping handle are connected to one another so that the ribs are not parallel to the primary cleaning direction.

In some embodiments either alone or in combination with one or more of the afore and/or aft mentioned embodiments, the gripping handle includes a first handle portion and a second handle portion each having the longitudinal axis. Here, the longitudinal axes of the first and second handle portions are angled with respect to one another

In some embodiments either alone or in combination with one or more of the afore and/or aft mentioned embodiments, the first and second handle portions each include the plurality of elastomeric gripping ribs running parallel to one another along the longitudinal axis, respectively.

In some embodiments either alone or in combination with one or more of the afore and/or aft mentioned embodiments, the cleaning tool and the gripping handle are connected to one another so that the plurality of elastomeric gripping ribs are perpendicular to the primary cleaning direction.

In some embodiments either alone or in combination with one or more of the afore and/or aft mentioned embodiments, the rigid base supports the ribs.

In some embodiments either alone or in combination with one or more of the afore and/or aft mentioned embodiments, the ribs depend upward from a web with the rigid base supporting the web.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a schematic view of an exemplary embodiment of an improved handle grip according to an exemplary embodiment of the present disclosure in use with a fan blade duster during use cleaning a fan blade;

FIG. 2 is an enlarged front view of the improved handle grip of FIG. 1;

FIG. 3 is an enlarged perspective view of the improved handle grip of FIG. 2;

FIGS. 4a through 4k are views of the improved handle grip of FIG. 2 showing the compression of the ribs;

FIG. 5 is a perspective view of the improved handle grip according to the present disclosure in use with a window squeegee;

FIG. 6 is a front view of the window squeegee of FIG. 5;

FIG. 7 is a perspective view of the improved handle grip according to the present disclosure in use with a combination window washer and squeegee tool;

FIG. 8 is a front view of the combination tool of FIG. 7;

FIG. 9 is a perspective view of the improved handle grip according to the present disclosure in use with a grout and tile brush;

FIG. 10 is an end view of the brush of FIG. 9;

FIG. 11 is a side view of an alternate embodiment of an improved handle grip according to the present disclosure; and

FIG. 12 is a sectional view of the handle grip of FIG. 11 taken along lines 11-11.

### DETAILED DESCRIPTION

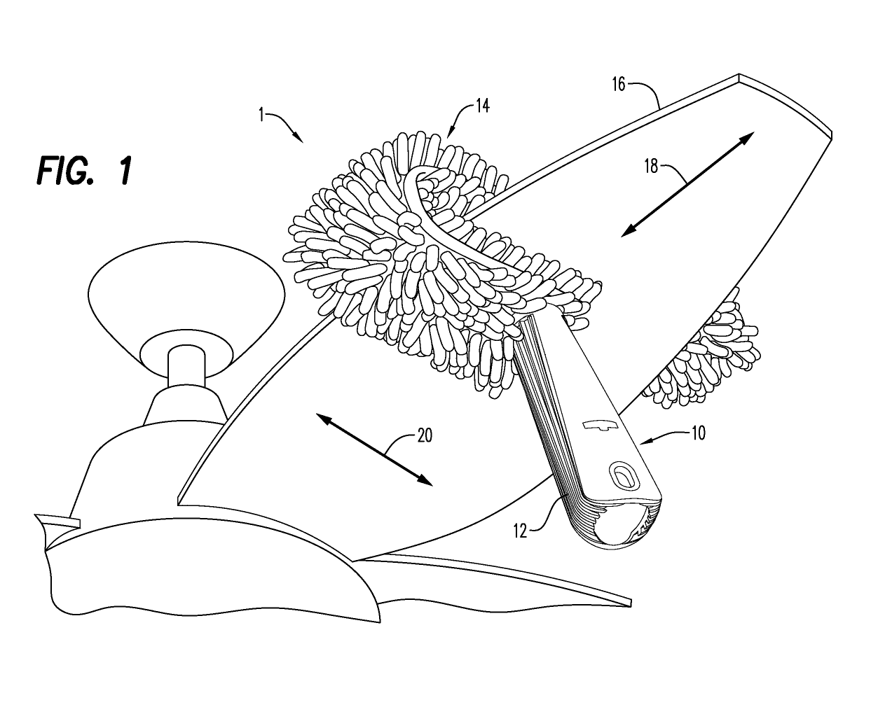

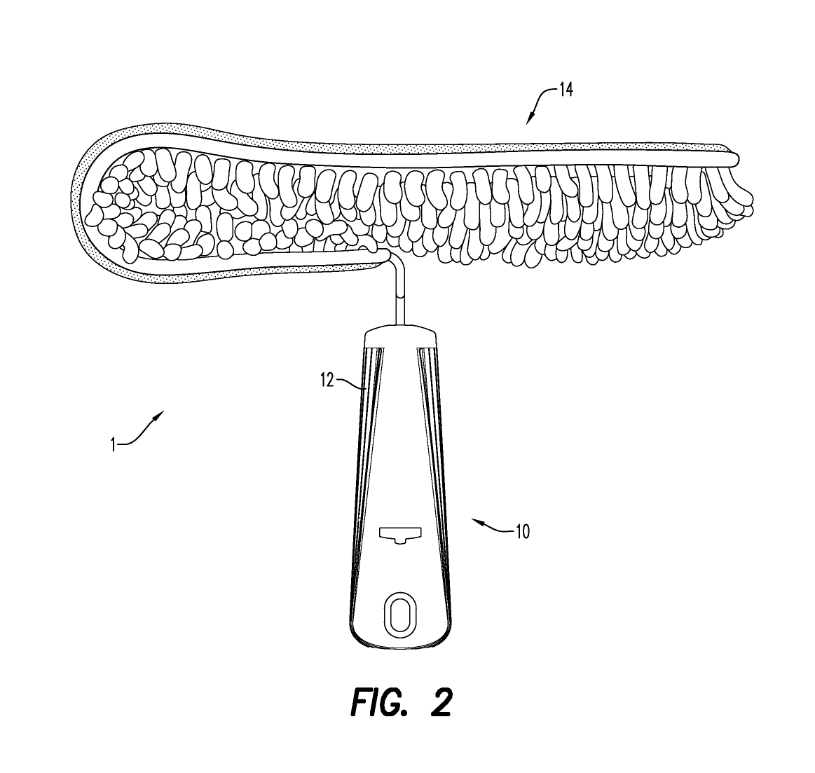

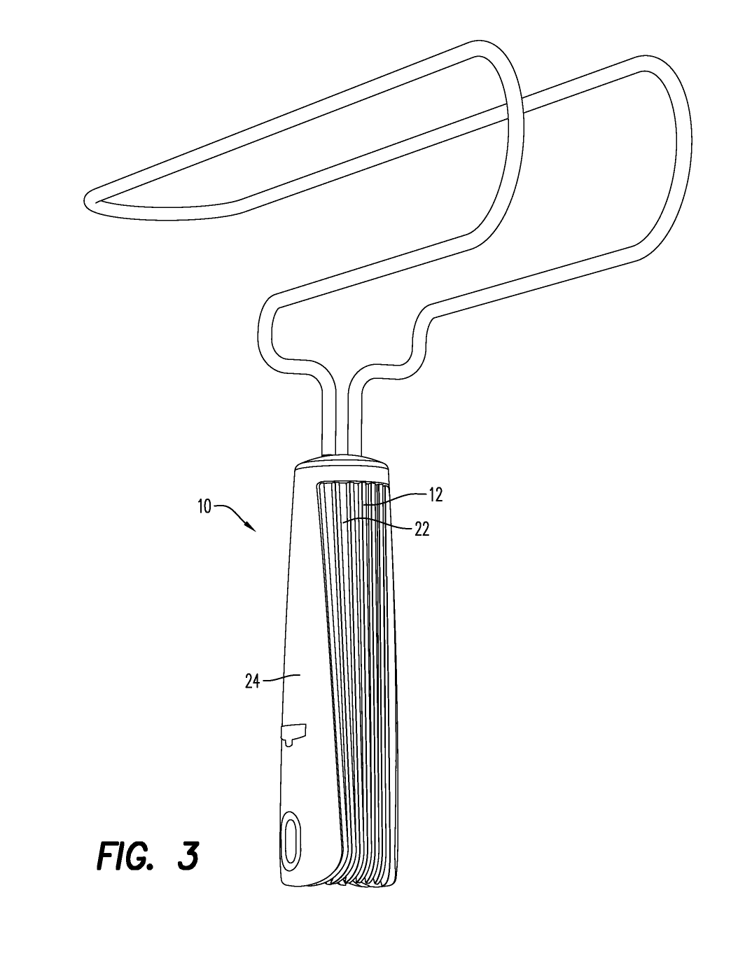

Referring to the drawings and in particular to FIGS. 1 through 4, an improved handle grip according to the present disclosure is shown and is generally referred to by reference numeral 10. Advantageously and as described in more detail herein, handle 10 includes a plurality of gripping ribs 12 that have a direction that is generally perpendicular or normal to a primary cleaning direction of the tool on which they are disposed and run in a direction along or parallel the longitudinal axis of the handle.

In this position, ribs 12 are positioned so that the user's fingers grip the ribs with the fingers perpendicular or normal to the direction of the ribs. Without wishing to be bound by any particular theory, it is believes that positioning ribs 12 both perpendicular to the user's fingers and perpendicular to the primary cleaning direction.

More specifically and with particular reference to FIG. 1, handle 10 is shown in use with a cleaning tool 14, which is illustrated by way of example as a fan blade cleaning tool, where the handle and tool together form a cleaning assembly 1. Here, assembly 1 is shown during a cleaning operation of a fan blade 16 in which cleaning tool 14 is moved in a primary cleaning direction 18 along the length of the blade and, in some instances, in a secondary cleaning direction 20 along the width of the blade.

As used herein, the term “primary cleaning direction” shall mean the direction movement of the tool and/or the direction of the vector of force without which cleaning would not be possible during an intended cleaning operation. In the example of the fan blade cleaning tool 14 discussed above, the intended cleaning operation is the removal of dust from the blade 16 and, thus, the primary cleaning direction 18 is the direction that moves tool 14 along the length of the blade and overcomes the frictional force between the blade and the tool.

Handle 10 includes the plurality of generally parallel gripping ribs 12 that depend upward from a web 22, where the web is supported by a rigid base 24. Thus, ribs 12 extend upward from web 22 in a spaced relationship from one another and are positioned on handle 10 in such a manner as to run perpendicular to the primary cleaning direction 18 and run parallel to the longitudinal axis of the handle.

Base 24 is formed from, for example, polypropylene, ABS, nylon, and others. Ribs 12 and web 22 are formed from, for example, a thermoplastic elastomer (TPE) having a durometer of between about 20-70, preferably 30-50, with about 40 being most preferred.

Without wishing to be bound by any particular theory, it is believed that elastomeric ribs 12, when running perpendicular to the primary cleaning direction 18 of cleaning too 14, in combination with elastomeric web 22 provide improved comfort and ability to maintain control of the cleaning tool and, thus, improving the usability of cleaning assembly 1.

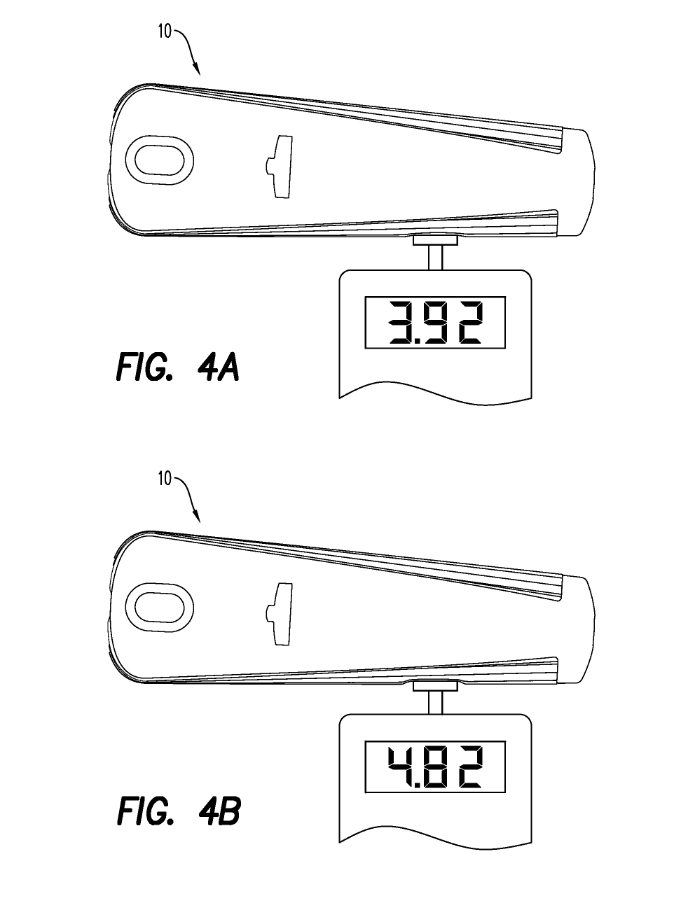

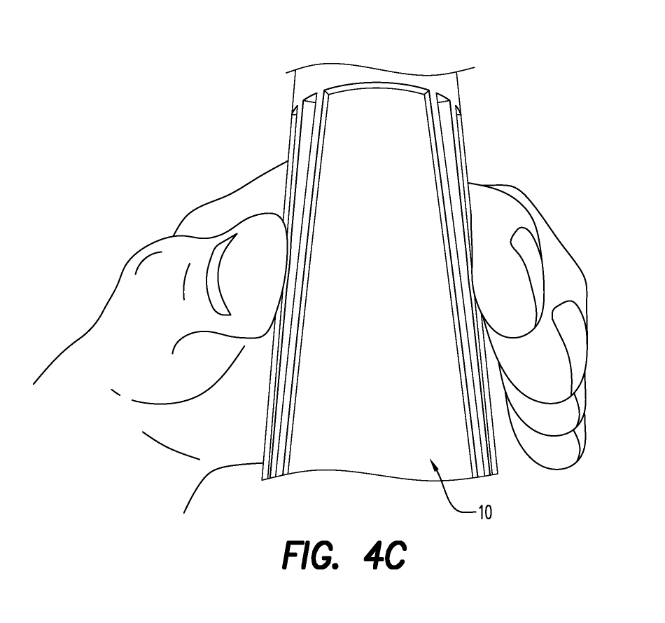

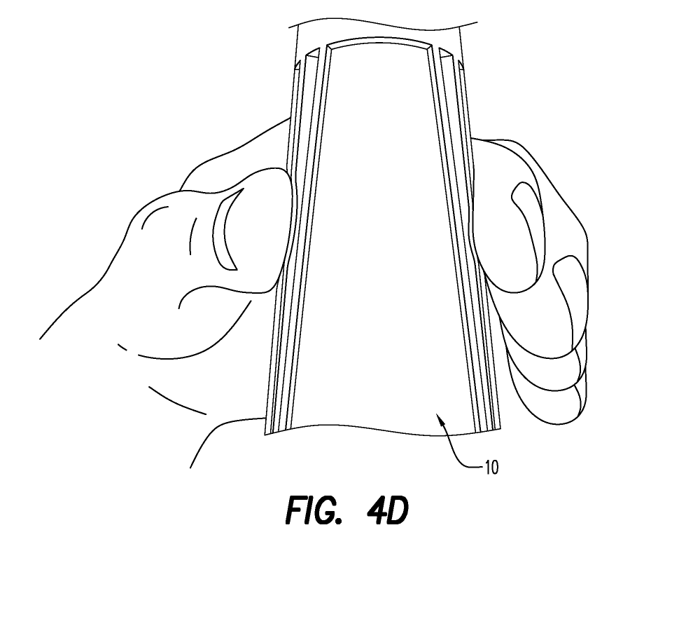

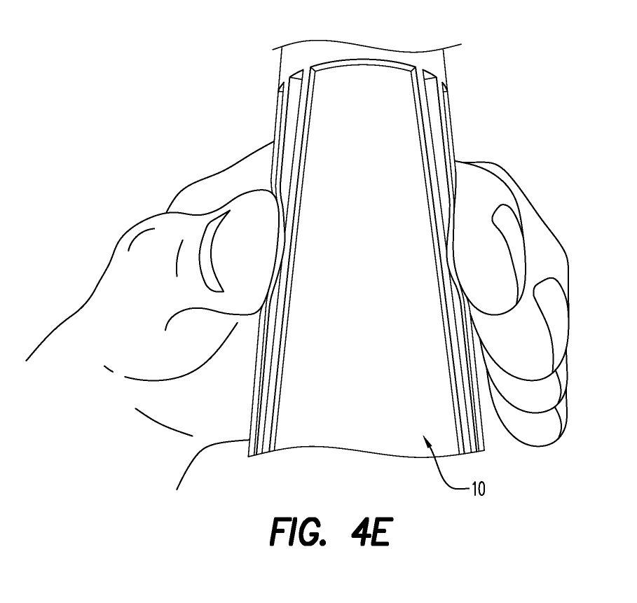

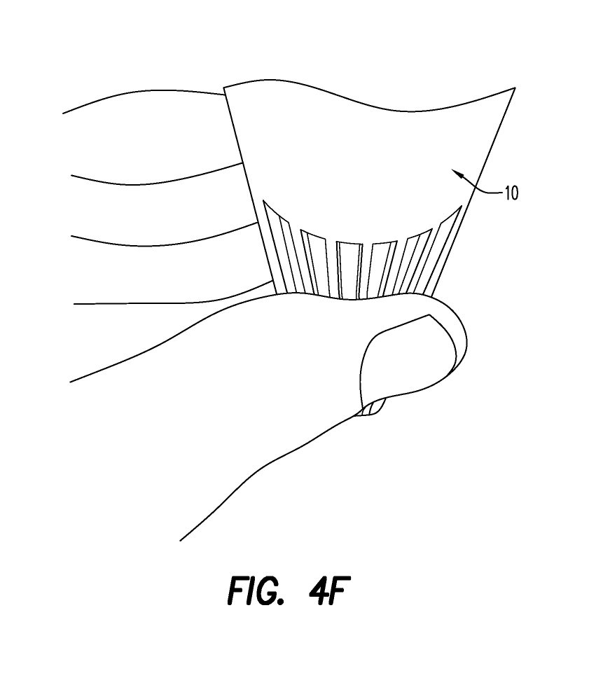

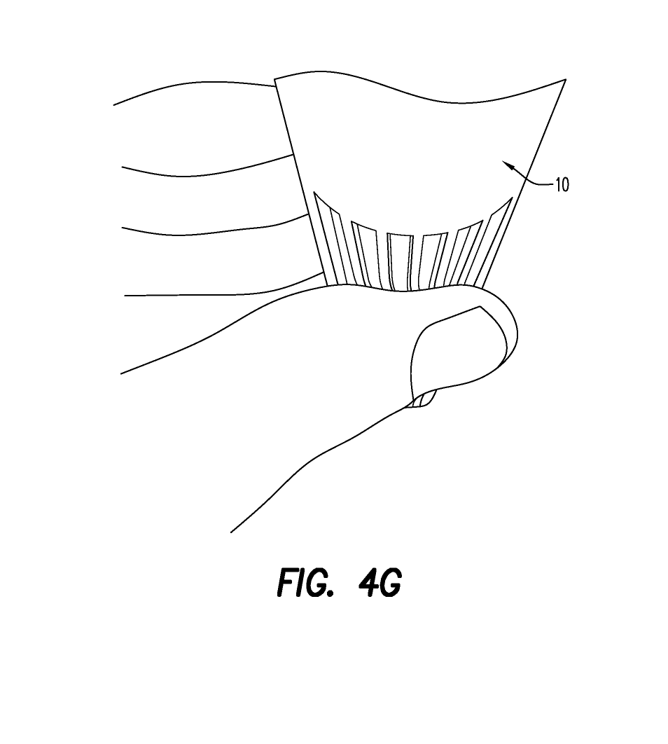

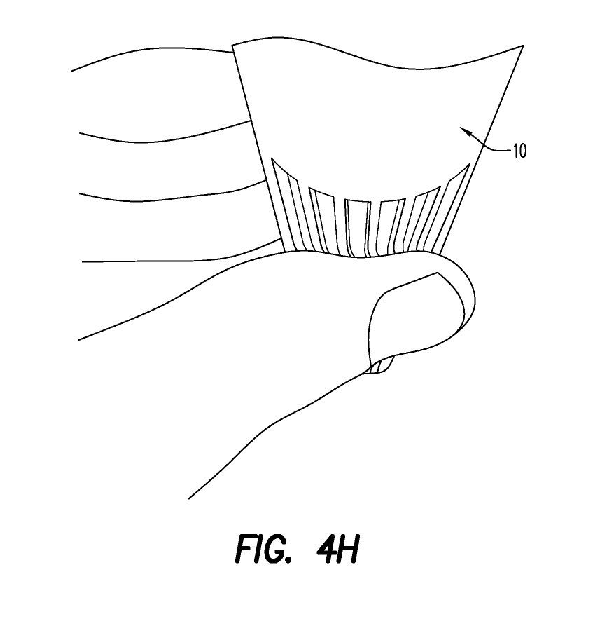

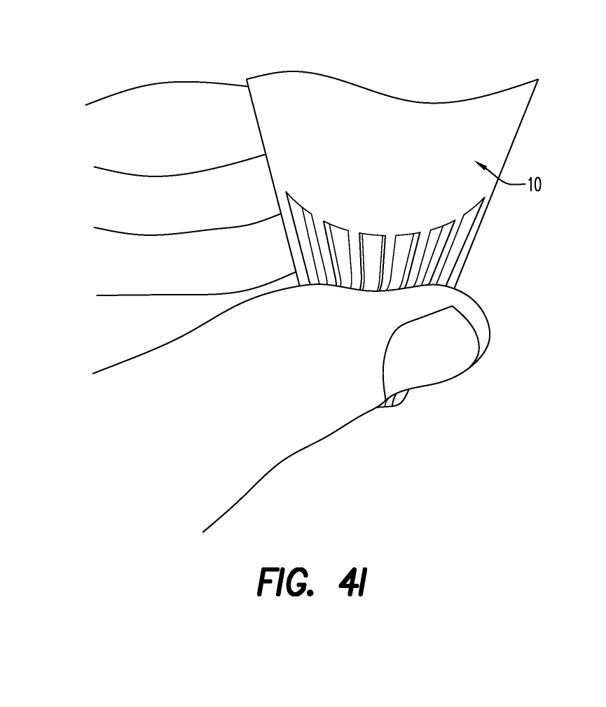

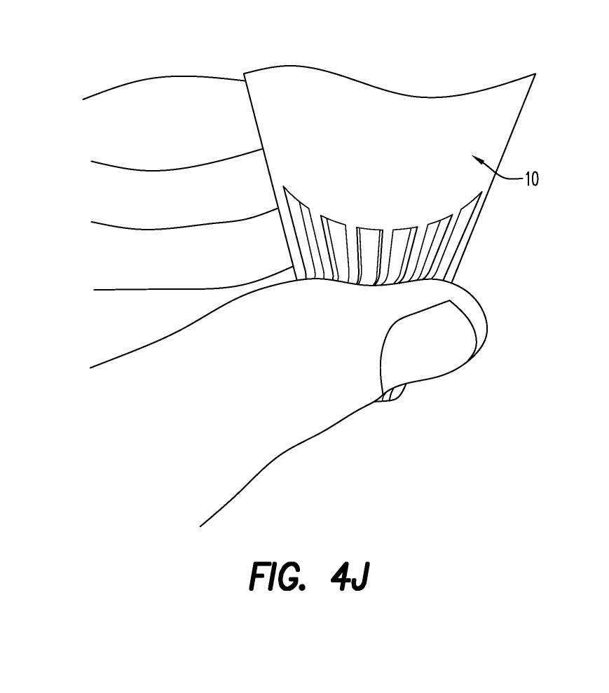

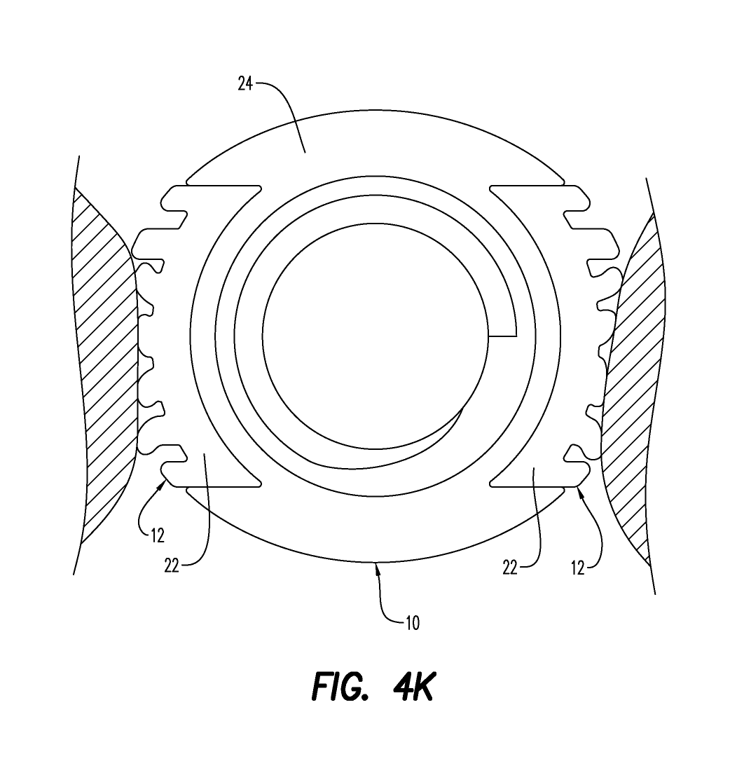

Handle 10 is shown in detail in FIGS. 4a through 4k during use to illustrate the compression of ribs 12 and web 22.

FIGS. 4a and 4b illustrate handle 10 being subjected compression with a pressure tester at a pressure of about 4 pounds and about 5 pounds, respectively.

FIGS. 4c, 4d, and 4e are side views that illustrate handle 10 being subjected compression by a user's hand in a pinch test with different levels of pressure and applied perpendicular to the ribs and at an angle to flex the ribs. Similarly, FIGS. 4f, 4g, 4h, 4i, and 4j are perspective views that illustrate handle 10 being subjected compression by a user's hand in a pinch test with different levels of pressure and applied perpendicular to the ribs and at an angle to flex the ribs.

As can be seen, the pressure results in ribs 12 compressing and/or folding over onto rigid base 24 and, when present, web 22, forming a dimple or pocket in which the user's fingers rest as schematically illustrated in FIG. k. Additionally and in some embodiments, the formation of the dimple or pocket can be assisted by deflection of web 22.

As can be seen, ribs 12 have a maximum height that tapers to a minimum height at their respective ends. Handle 10 is configured with a maximum height of ribs 12 of preferably greater than 0.5 millimeters (mm) and a width of the ribs of preferably less than 5 mm. The height of rib 12 is measured from the base of rib—namely where the rib depends from web 22. Similarly, the width of rib 12 is measured where the rib depends from web 22.

In some embodiments, handle 10 is configured so that ribs 12 have a ratio of maximum height to width of between 4:1 and 1:4, more preferably between 3:1 and 1:3, with between 2:1 and 1:1 being most preferred, and any subranges therebetween.

It is believed that combination of the soft ribs 12, and when present web 22, and the rib height to width ratio allow for the formation of the formation of the dimple or pocket at typical gripping forces. Moreover, it is believed that the dimple or pocket formation in combination of the orientation of the ribs with respect to the longitudinal axis of handle 10 (i.e., parallel), with respect to the user's fingers (i.e., perpendicular), and with respect to the primary cleaning direction 18 (i.e., parallel) allow for increased control and comfort of tool 14, namely a grip that resists rotation of handle 10 about its longitudinal axis in the user's hand.

In some embodiments, ribs 12 and web 22 are over-molded or co-molded onto rigid base 24 so that handle 10 is an integrally formed unit. In other embodiments, ribs 12 and web 22 are integrally formed together separate from rigid base 24 and is later secured to the base using one or more of a mechanical connection such as, but not limited to a friction fit or a press fit, an adhesive connection, and a thermal connection such as, but not limited to, an ultrasonic welding connection.

It should be recognized that handle 10 is shown by way of example as including web 22 external to rigid base 24. Of course, it is contemplated by the present disclosure for handle 10 to be configured with web 22 either absent or, contained within the rigid base.

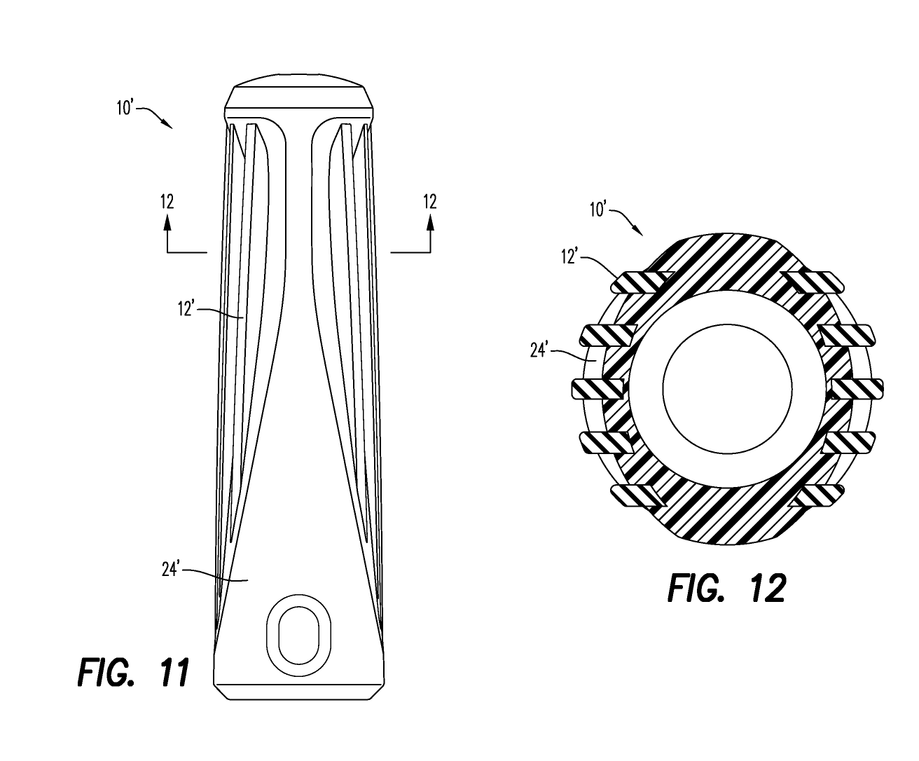

An example of this configuration is shown in FIGS. 11 and 12. Here, handle 10′ includes a plurality of generally parallel gripping ribs 12′ that depend upward from rigid base 24′. Thus, ribs 12′ extend in a spaced relationship from one another and are positioned on handle 10′ in such a manner as to run perpendicular to the primary cleaning direction as discussed in detail. Here, ribs 12′ is over-molded or co-molded onto rigid base 24′ so that handle 10′ is an integrally formed unit.

Handle 10 has been described above in assembly 1 with respect to cleaning tool 14, which was illustrated by way of example as a fan blade dusting tool. Of course, handle 10 is contemplated for use with any cleaning tool provided that the handle is oriented so that ribs 12 are generally perpendicular to the primary cleaning direction 18 of the tool 14.

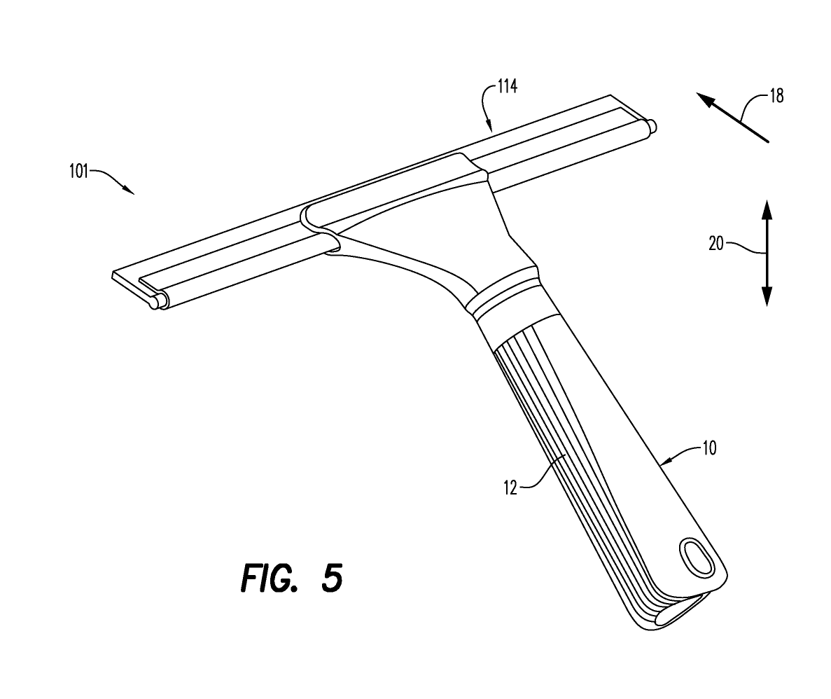

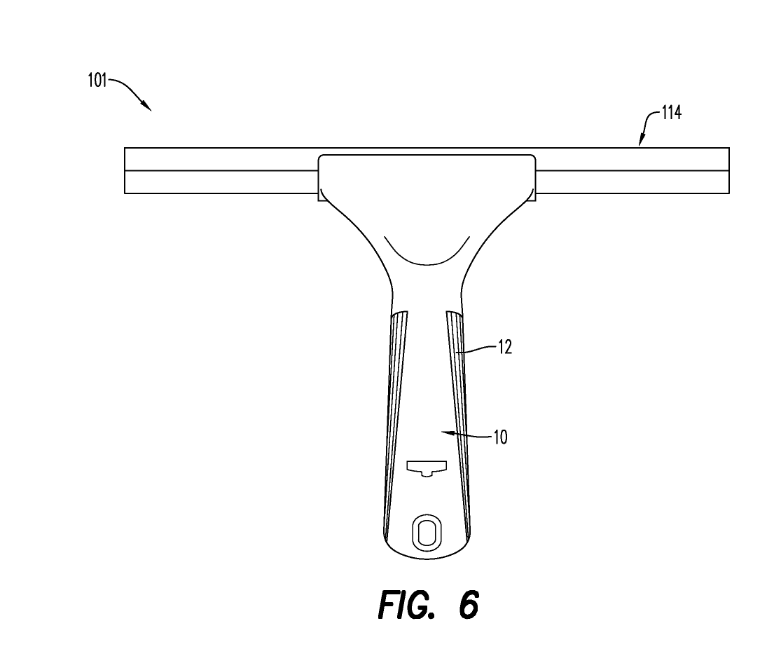

For example, handle 10 is shown in FIGS. 5 and 6 as an assembly 101 in use with a cleaning tool 114, which is illustrated as a window squeegee. Here, the cleaning tool 114 has a primary cleaning direction 18 towards the window—namely so that the blade of the squeegee is pressed against the window—and a secondary cleaning direction 20 across (e.g., vertically, horizontally, diagonally, etc.) the window—so that the blade of the squeegee is moved across the window surface.

Again, handle 10 is oriented with respect to cleaning tool 114 so that ribs 12 are generally perpendicular to the primary cleaning direction 18 and the ribs are parallel to the longitudinal axis of handle 10, which is believed by the present disclosure to provide improved control and comfort to the user during use.

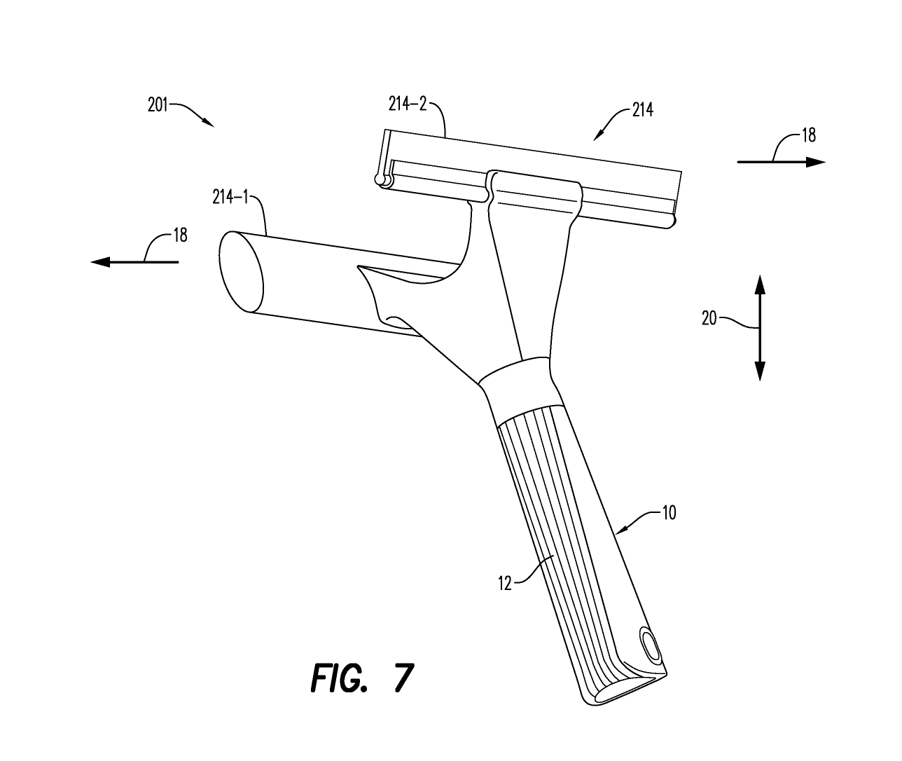

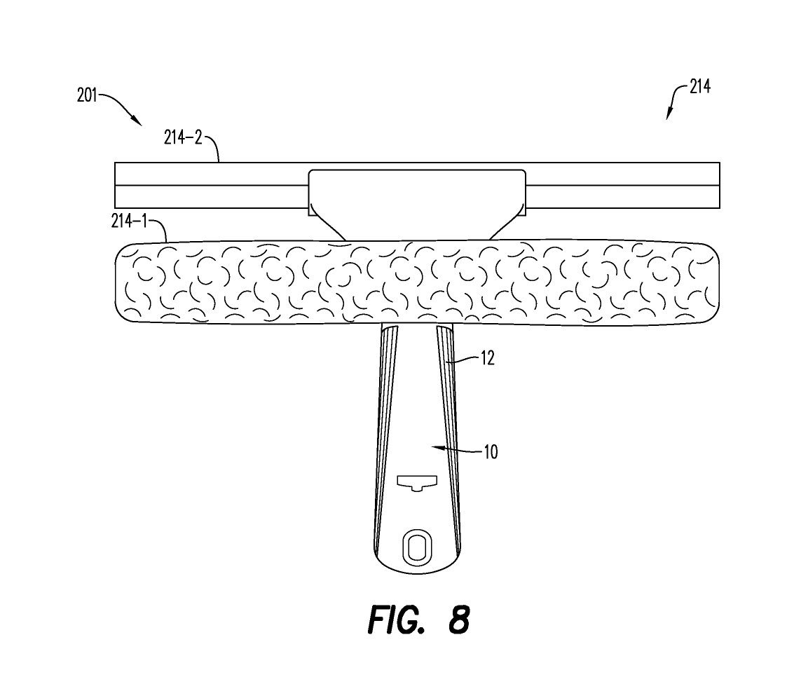

Additionally, handle 10 is shown in FIGS. 7 and 8 as an assembly 201 in use with a cleaning tool 214, which is illustrated as a combination window washer 214-1 and squeegee 214-2. Since cleaning tool 214 has two tools, washer 214-1 and squeegee 214-2, the tool also has two primary cleaning directions 18 both towards the window—namely so that the material of the window washer 214-1 or the blade of the squeegee 214-2 is pressed against the window—and a secondary cleaning direction 20 across (e.g., vertically, horizontally, diagonally, etc.) the window—so that the washer or blade is moved across the window surface.

Again, handle 10 is oriented with respect to cleaning tool 214 so that ribs 12 are generally perpendicular to the primary cleaning directions 18 and the ribs are parallel to the longitudinal axis of handle 10, which is believed by the present disclosure to provide improved control and comfort to the user during use.

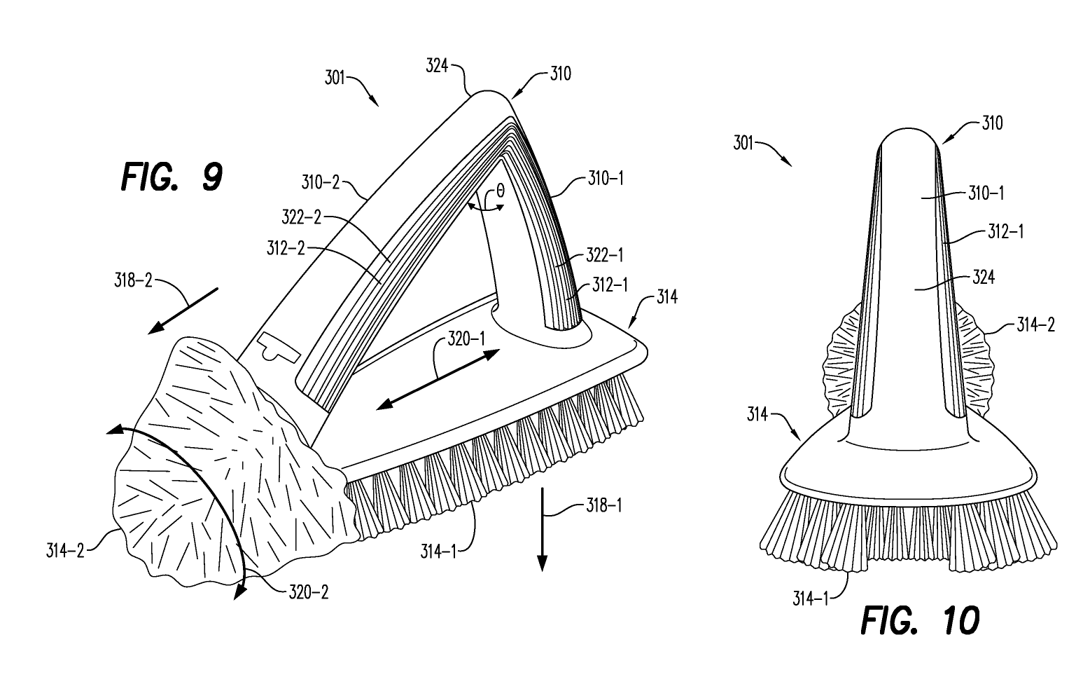

Turning now to FIGS. 9 and 10, an alternate exemplary embodiment of an improved gripping handle according to the present disclosure is shown and is generally referred to by reference numeral 310. Here, handle 310 is shown as an assembly 301 in use with a cleaning tool 314, which as shown as a brush having a grout cleaning portion 314-1 and a corner cleaning portion 314-2.

As discussed above with respect to the cleaning tool 214 of FIGS. 7 and 8 that has two cleaning portions 214-1 and 214-2 with multiple primary and secondary cleaning directions, cleaning tool 314 has primary and secondary cleaning directions for each of the cleaning portions 314-1, 314-2.

Here, first cleaning portion 314-1 has a primary cleaning direction 318-1—so that the brush is pushed downwards against the surface being cleaned—and a secondary cleaning direction 320-1—so that the brush is moved along the surface being cleaned.

Additionally, second cleaning portion 314-2 has a primary cleaning direction 318-2—so that the brush is pushed into the corner being cleaned—and a secondary cleaning direction 320-2—so that the brush is rotated in corner being cleaned.

Different from the embodiments discussed above, handle 310 includes a first handle portion 310-1 and a second handle portion 310-2. First and second handle portions 310-1, 310-2 are connected to one another at a predetermined angle θ. The angle θ is preferably between 10 degrees and 80 degrees, more preferably between 20 degrees and 70 degrees, with about 60 degrees being most preferred, and any sub-ranges therebetween.

Handle 310, namely first and second handle portions 310-1 and 310-2, respectively, include a plurality of generally parallel gripping ribs 312-1, 312-2 that depend upward from a web 322-1, 322-2, where the web is supported by a rigid base 324. Thus, ribs 312-1, 312-2 extend upward from web 322-1, 322-2 in a spaced relationship from one another. In some embodiments, the ribs 312-1, 312-2 run continuously from the first portion 310-1 to the second portion 310-2 and are disposed at the intersection of the portions at the angle θ with respect to one another.

When using first cleaning portion 314-1, a user will typically grasp both first and second handle portions 310-1 and 310-2, allowing them to push and pull the first cleaning portion along secondary cleaning direction 320-1 while pressing the first cleaning portion against the surface being cleaned in the primary cleaning direction 318-1. Although ribs 312-1 and 312-2 are not perpendicular to the primary cleaning direction 318-1, the ribs are angled or not parallel to the primary cleaning direction which is believed by the present disclosure to at least assist in increasing the comfort and control of cleaning tool 314.

When using second cleaning portion 314-2, a user will typically grasp first handle portion 310-1, allowing them to push the second cleaning portion along primary cleaning direction 318-2 into the corner while twisting the second cleaning portion in the corner in the secondary cleaning direction 320-2. Here, ribs 312-1 are generally perpendicular to the primary cleaning direction 318-2 and the ribs are parallel to the longitudinal axis of handle 310-1 in the manner discussed above.

It should be recognized that tool 314 is described by way of example as having handle 310 with two portions 310-1, 310-2 and with such portions at angles with respect to one another. Of course, it is contemplated by the present disclosure for tool 314 to have any desired number of portions more or less than the two portions and for such portions to have any angle with respect to one another.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A cleaning assembly, comprising:
a cleaning tool with a primary cleaning direction; and
a gripping handle connected to the cleaning tool, the gripping handle having a rigid base with a longitudinal axis and a plurality of elastomeric gripping ribs, the plurality of elastomeric gripping ribs running parallel to one another along the longitudinal axis, the cleaning tool and the gripping handle being connected to one another so that the plurality of elastomeric gripping ribs are not parallel to the primary cleaning direction.

2. The cleaning assembly of claim 1, wherein the cleaning tool and the gripping handle being connected to one another so that the plurality of elastomeric gripping ribs are perpendicular to the primary cleaning direction.

3. The cleaning assembly of claim 1, wherein the cleaning tool is selected from the group consisting of fan blade cleaning tool, a dusting tool, a squeegee, a window washer, and a brush.

4. The cleaning assembly of claim 1, wherein the plurality of elastomeric gripping ribs depend upward from a web, the rigid base supporting the web.

5. The cleaning assembly of claim 4, wherein the plurality of elastomeric gripping ribs and the web are molded onto the rigid base so that the gripping handle is an integrally formed unit.

6. The cleaning assembly of claim 4, wherein the plurality of elastomeric gripping ribs and the web are formed a thermoplastic elastomer having a durometer of between 20 and 70.

7. The cleaning assembly of claim 4, wherein the plurality of elastomeric gripping ribs have a ratio of maximum height to width of between 4:1 and 1:4.

8. The cleaning assembly of claim 4, wherein pressure applied to the plurality of elastomeric gripping ribs by a user's fingers results in the ribs compressing and/or folding over and forming a dimple or pocket in which the user's fingers rest.

9. The cleaning assembly of claim 8, wherein the pressure applied to the plurality of elastomeric gripping ribs results in deflection of the ribs and/or web to form the dimple or pocket.

10. The cleaning assembly of claim 1, wherein the rigid base supports the plurality of elastomeric gripping ribs.

11. The cleaning assembly of claim 10, wherein the plurality of elastomeric gripping ribs are molded onto the rigid base so that the gripping handle is an integrally formed unit.

12. The cleaning assembly of claim 10, wherein the plurality of elastomeric gripping ribs have a ratio of maximum height to width of between 4:1 and 1:4.

13. The cleaning assembly of claim 10, wherein pressure applied to the plurality of elastomeric gripping ribs by a user's fingers results in the ribs compressing and/or folding over and forming a dimple or pocket in which the user's fingers rest.

14. The cleaning assembly of claim 1, wherein the gripping handle includes a first handle portion and a second handle portion each having the longitudinal axis, the longitudinal axes of the first and second handle portions being angled with respect to one another.

15. The cleaning assembly of claim 14, wherein the first and second handle portions each comprise the plurality of elastomeric gripping ribs running parallel to one another along the longitudinal axis, respectively.

16. The cleaning assembly of claim 15, wherein the plurality of elastomeric gripping ribs run continuously from the first handle portion to the second handle portion.

17. A cleaning assembly, comprising:
a cleaning tool with a primary cleaning direction; and
a gripping handle connected to the cleaning tool, the gripping handle having a rigid base with a longitudinal axis and a plurality of elastomeric gripping ribs, the plurality of elastomeric gripping ribs running parallel to one another along the longitudinal axis, the plurality of elastomeric gripping ribs having a durometer of between 20-70 and a ratio of maximum height to width of between 4:1 and 1:4.

18. The cleaning assembly of claim 17, wherein the cleaning tool and the gripping handle are connected to one another so that the plurality of elastomeric gripping ribs are not parallel to the primary cleaning direction.

19. The cleaning assembly of claim 18, wherein the gripping handle includes a first handle portion and a second handle portion each having the longitudinal axis, the longitudinal axes of the first and second handle portions being angled with respect to one another

20. The cleaning assembly of claim 19, wherein the first and second handle portions each comprise the plurality of elastomeric gripping ribs running parallel to one another along the longitudinal axis, respectively.

21. The cleaning assembly of claim 17, wherein the cleaning tool and the gripping handle are connected to one another so that the plurality of elastomeric gripping ribs are perpendicular to the primary cleaning direction.

22. The cleaning assembly of claim 17, wherein the rigid base supports the plurality of elastomeric gripping ribs.

23. The cleaning assembly of claim 17, wherein the plurality of elastomeric gripping ribs depend upward from a web, the rigid base supporting the web.
